(19) United States
(12) Patent Application Publication
(10) Pub. No.: US 2012/0040182 A1
(43) Pub. Date: Feb. 16, 2012

(54) ADHESIVE FILM HAVING RESILIENT PROPERTIES

(75) Inventors: Hermann Neuhaus-Steinmetz, Ahrensburg (DE); Lars Guldbrandsen, Hamburg (DE); Sven König, Reinach (DE)

(73) Assignee: TESA SE, Hamburg (DE)

(21) Appl. No.: 13/256,796

(22) PCT Filed: Jan. 18, 2010
(86) PCT No.: PCT/EP2010/050539

§ 371 Date: Oct. 12, 2011

(30) Foreign Application Priority Data
Apr. 24, 2009 (DE) 10 2009 018 519.4

(51) Int. Cl. B32B 7/12; B05D 5/10

(52) U.S. Cl. 428/354; 427/207.1

(57) ABSTRACT

Adhesive film, useful in a punching process, having a support and at least one layer of adhesive substance, the adhesive substance having two or more lower layers at least one of which is in a mechanically tensioned state.

The invention relates to an adhesive sheet having resilience properties, to a process for producing it, and also to punched products produced using an adhesive sheet of this kind.

Front plates with writing on and functional plates for electronic and other devices are adhered in large quantities industrially to housings or other substrates using double-sided adhesive tapes. Punches are used to bring the adhesive tape, starting from roll or bale material, into the desired shape. At the punched-through edges, however, the adhesives tend to coalesce again, since there are no forces present for retraction from the punched edges. This is so even more if the punched, shaped areas are removed not immediately but only at a later point in time, as is the case particularly with manual further processing.

In the case of prior-art, double-sided adhesive tapes used customarily, the partial recoalescence of adhesives at punched and cut edges in automatic processing leads to lower machine speeds and increased rejection. In manual processing the partial recoalescence of adhesives leads to considerable extra processing work.

DE 100 52 955 A1 discloses the use of pressure-sensitive adhesives having anisotropy properties for punched products. The anisotropy properties give such pressure-sensitive adhesives a resilience if they are coated in the drawn state onto a backing.

Publications DE 101 57 152 A1 and 101 57 153 A1 describe processes for producing punched pressure-sensitive adhesive products by means of pressure-sensitive adhesives of this kind. There, adhesives are applied to a backing using coating dies, in the stretched state. The elastic recession forces of the adhesives result in their retraction from punched and cut edges during processing, whereby any diminishment in flowback with the consequence of unwanted resticking is reduced.

Owing to the viscoelasticity properties that are needed for an adhesive tape, with the ability to flow out on substrates, the tension state brought about by applying the adhesive in the stretched state subsides within a few weeks. Consequently, an adhesive tape produced in this way must be processed a short time after production, so that the desired effect can come about. Particularly in the case of transport and storage in hot regions, this time is further curtailed, so that in these regions the work required for the processing of such adhesive tapes is almost impossible to accomplish.

Furthermore, in the course of production, the adhesive is stretched only in the running direction of the machine, so that the desired effect is observable only in the case of punched or cut edges transverse to the running direction. In the case of punched or cut edges in the longitudinal direction, exactly the same tendency toward resticking is present as with conventional adhesive tapes.

It is an object of the invention to provide adhesive sheets which as compared with the state of the art have improved processing properties, especially in punching or diecutting operations, for which, in particular during or after a punching or cutting operation, the punched or cut edges do not stick to one another again, and which exhibit the advantageous properties for a sufficiently long period of time.

This object is achieved by means of the features of claims 1, 9 and 14. Useful embodiments of the inventions arise from the features of claims 2 to 8 and 10 to 13.

The invention accordingly provides an adhesive sheet, particularly for use in a punching operation, which comprises a backing and at least one layer of an adhesive, the adhesive having two or more sublayers and at least one of the sublayers being present in a mechanically tensioned state.

By virtue of the sublayer present in a mechanically tensioned state, the adhesive sheet of the invention has advantageous properties. In particular, coalescence of the adhesive is prevented not at punched or cut edges which run transverse to the running direction, but instead also in respect of punched or cut edges in the longitudinal direction. Furthermore, coalescence is prevented for a considerably longer period of time by comparison with the adhesive sheets known to date.

In one embodiment of the invention, the adhesive sheet has a backing and layers of an adhesive on both sides of the backing, with one or both layers of adhesive being composed of sublayers having different properties, and with at least one of the sublayers being mechanically tensioned.

The term “sheet” in the present invention refers to sheetlike structures of all kinds and in particular also embraces two-dimensionally sheetlike structures (e.g., roll product, bale product) and also elongate structures (e.g., adhesive tapes). The term “sheet” likewise embraces structures whose two-dimensional extent is limited (e.g., labels).

The backing is coated on one side or both sides with a layer of an adhesive. This layer of an adhesive is also referred to below as layer of adhesive. The layer of adhesive consists of a plurality of sublayers. The term “sublayer” here denotes a part of the layer of adhesive, this part itself being of layerlike design. The layer of adhesive comprises at least two such sublayers. One of these sublayers is present in a mechanically tensioned state.

The expression “sublayer in a mechanically tensioned state” refers here in particular to a sublayer having mechanical properties the effect of which is that in the sublayer the tensions, as a result of the drawn state, undergo relaxation only after a very long time. The mechanically tensioned state of the sublayer is preferably frozen in.

As a result of the mechanically tensioned state, the adhesive sheets of the invention have a resilience, and so in the punching, cutting or squeezing operation there is retraction of the mechanically tensioned sublayers of adhesive and hence of the layer of adhesive as a whole. Recoalescence of the adhesive after punching, cutting or squeezing of the adhesive sheet is therefore prevented.

The outer sublayer of the layer of adhesive, i.e., the sublayer remote from the backing, is preferably adhesive, while at least one of the sublayers facing the backing, as for example the sublayer which adjoins the backing, is a sublayer which is present in a mechanically tensioned state.

The resilience of the adhesive sheet can be brought about by drawing the layers of adhesive in the course of coating, and placing them in the drawn state onto the backing or a release liner. This operation may take place, for example, using an extrusion die whose slot for the emergence of adhesive is significantly larger than the subsequent layer thickness of the adhesive on the substrate.

In accordance with one preferred embodiment of the invention, the drawing is done monoaxially, more preferably in the longitudinal direction (die emergence direction). It is also possible for drawing to be performed in the transverse direction as well, giving a biaxial drawing.

Advantageous adhesive sheets of the invention are double-sidedly adhesive; in such sheets, accordingly, the backing is coated double-sidedly with adhesive.

The invention further provides a process for producing the adhesive sheet of the invention, in which an adhesive which comprises two or more sublayers is coated in the drawn state onto a sheetlike material to give the layer of adhesive, with at least one of the sublayers of the layer of adhesive being present in a mechanically tensioned state.

In one advantageous embodiment of the process of the invention, a backing is coated via a co-extrusion die with an adhesive consisting of two or more sublayers, in the drawn state, and crosslinked. In this case, at least the outer sublayer is adhesive. At least one of the—preferably not outer—sublayers has mechanical properties the effect of which is that the tensions owing to the drawn state undergo relaxation only after a very long time. After crosslinking has taken place, the layer of adhesive is lined with a release liner. In the next workstep, the other side of the backing is coated via a co-extrusion die with an adhesive consisting of two or more sublayers, in the drawn state, and crosslinked. In this case, at least the outer sublayer is adhesive. At least one of the—preferably not outer—sublayers has mechanical properties the effect of which is that the tensions owing to the drawn state undergo relaxation only after a very long time.

In a further advantageous embodiment of the process of the invention, a release liner is coated via a co-extrusion die with an adhesive which is present in the drawn state, consisting of two or more sublayers, and is subsequently crosslinked. In this case, at least the outer sublayer is adhesive. At least one of the—preferably not outer—sublayers of the layer of adhesive has mechanical properties the effect of which is that the tensions owing to the drawn state undergo relaxation only after a very long time. After crosslinking has taken place, the backing is laminated onto the layer of composition. In the next workstep, the other side of the backing is coated via a co-extrusion die with a composition which is present in the drawn state, consisting of two or more sublayers, and is subsequently crosslinked. In this case, at least the outer sublayer is adhesive. At least one of the—preferably not outer—sublayers has mechanical properties the effect of which is that the tensions owing to the drawn state undergo relaxation only after a very long time.

In a further advantageous embodiment, an adhesive which is present in the drawn state, consisting of two or more sublayers, is coated via a co-extrusion die onto a roller having a surface from which an adhesive composition can be removed again, it being possible for the release effect of the composition's surface to be achieved, for example, by way of a texture, a coating, an accompanying release web or else a layer of fluid on the roller. Crosslinking takes place on the roller described. After crosslinking has taken place, the adhesive is laminated onto a release liner. With regard to the adhesive, at least the sublayer facing the release liner is adhesive. At least one of the sublayers has mechanical properties the effect of which is that the tensions owing to the drawn state undergo relaxation only after a very long time. After crosslinking has taken place, the backing is laminated onto the layer of adhesive. In the next workstep, again, an adhesive which is identical or similar in terms of construction and has two or more sublayers is coated via a co-extrusion die onto an identical roller, in the drawn state, and crosslinked. The composition is subsequently laminated from the roller onto the backing side of the assembly from the preceding workstep.

A further-improved resilience on the part of the adhesive sheet is achieved if at least one adhesive has an elastic resilience. In the case of double-sided adhesive sheets, advantageously both adhesives exhibit such resilience.

As adhesives with inherent resilience it is advantageous to use anisotropic adhesives.

Particularly suitable as adhesives with inherent resilience are pressure-sensitive adhesives based to an extent of at least 65% by weight on at least one acrylic monomer from the group of the compounds of the general formula CH₂=(CR¹)COOR², where R¹=H or CH₃ and R² is selected to be H, CH₃ or from the group of the branched or unbranched, saturated alkyl groups having 2 to 20 C atoms, and for which, moreover, the average molecular weight M_{W} is at least 650 000 g/mol. When applied to a backing, the pressure-sensitive adhesive possesses a preferential direction such that the refractive index measured in the preferential direction, n_{MD}, is greater than the refractive index measured in a direction perpendicular to the preferential direction, n_{CD}, with the difference Δn=n_{MD}−n_{CD} being at least 1×10⁻⁵.

The weight-average molecular weight M_{W} is determined by means of gel permeation chromatography (GPC). The eluent used is THF with 0.1% by volume trifluoroacetic acid.

Measurement takes place at 25° C. A preliminary column used is PSS-SDV, 5 μ, 10³ Å, ID 8.0 mm×50 mm. Separation takes place using the column PSS-SDV, 5 μ, 10³ and also 10⁵ and 10⁶, each with ID 8.0 mm×300 mm. The sample concentration is 4 g/l, the flow rate 1.0 ml per minute. Measurement is made against PMMA standards. (μ=μm; 1 Å=10⁻¹⁰ m).

The refractive index (formerly referred to as index of refraction) is a physical constant which gives the optical density or rate of propagation of light waves in a material. The refractive index of the adhesives is determined using an Abbe refractometer in accordance with DIN 51423. In accordance with the DIN specification, measurement takes place with temperature conditioning to 20° C. and at a wavelength of 589 nm with a sodium spectral lamp (refractive index for the sodium d-line, correspondingly, 589 nm at 20° C.).

Also suitable as adhesives for producing the layer of adhesive of the invention are pressure-sensitive adhesive systems which comprise at least one pressure-sensitive adhesive based on at least one block copolymer, the weight fractions of the block copolymers in total accounting for at least 50% of the pressure-sensitive adhesive, with at least one block copolymer being composed at least partially on the basis of (meth)acrylic acid derivatives, and with, additionally, at least one block copolymer comprising at least the unit P(A)-P(B)-P(A), comprising at least one polymer block P(B) and at least two polymer blocks P(A), and where
P(A) independently of one another represent homopolymer or copolymer blocks of monomers A, the polymer blocks P(A) each having a softening temperature in the range from +20° C. to +175° C.,
P(B) represents a homopolymer or copolymer block of monomers B, the polymer block P(B) having a softening temperature in the range from −130° C. to +10° C.,
the polymer blocks P(A) and P(B) are not homogeneously miscible with one another, and
the pressure-sensitive adhesive system is oriented, in that it possesses a preferential direction, with the refractive index measured in the preferential direction, n_{MD}, being greater than the refractive index measured in a direction perpendicular to the preferential direction, n_{CD}.

The invention further provides punched products produced by punching an adhesive sheet of the invention.

The invention is elucidated in more detail below by means of examples, with reference to the drawings. In the drawings

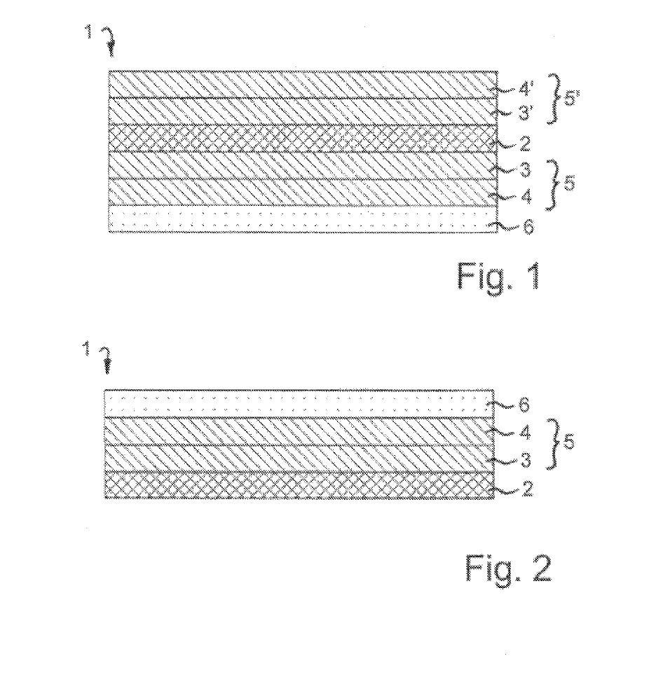

FIG. 1 shows a schematic cross-sectional representation of a first embodiment of the adhesive sheet, in which the backing is coated on both sides with a layer of adhesive; and

FIG. 2 shows a schematic cross-sectional representation of a second embodiment of the adhesive sheet, in which the backing is coated only on one side with a layer of adhesive.

### EXAMPLES

The embodiment of the adhesive sheet 1 of the invention that is shown in FIG. 1 is equipped on both sides with a layer of adhesive 5, 5′. The adhesive sheet 1 has a backing 2 whose first surface is coated with a first layer of adhesive 5. The layer of adhesive 5 consists of two sublayers 3, 4. The inner sublayer 3, facing the backing 2, of the layer of adhesive 5 is present in the mechanically tensioned state, whereas the outer sublayer 4, remote from the backing 2, of the layer of adhesive 5 is equipped adhesively.

The second surface of the backing 2 is coated with a second layer of adhesive 5′. The layer of adhesive 5′ consists of two sublayers 3′, 4′. The inner sublayer 3′, facing the backing 2, of the second layer of adhesive 5′ is present in the mechanically tensioned state, while the outer sublayer 4′, remote from the backing 2, of the layer of adhesive 5′ is equipped adhesively.

Prior to the application of the second layer of adhesive 5′, a release liner 6 was applied to the layer of adhesive 5.

Each of the layers of adhesive 5, 5′ may comprise further sublayers. Furthermore, the layers of adhesive 5, 5′ may differ not only in construction, in respect for example of the number of sublayers, but also in the chemical composition of the sublayers.

The adhesive sheet shown in FIG. 2 is coated only on one side with a layer of adhesive (5). The layer of adhesive 5 consists of two sublayers 3, 4. The inner sublayer 3, facing the backing 2, of the layer of adhesive 5 is present in the mechanically tensioned state, while the outer sublayer 4, remote from the backing 2, of the layer of adhesive 5 is equipped adhesively. The layer of adhesive 5 may comprise further sublayers.

### LIST OF REFERENCE SYMBOLS

1 adhesive sheet
2 backing
3 inner sublayer (in the mechanically tensioned state)
4 outer layer (adhesive)
5 adhesive, consisting of the inner sublayer 3 and the outer sublayer 4
6 release liner
3′ inner sublayer of a second adhesive
4′ outer sublayer of a second adhesive

1. An adhesive sheet, for use in a punching operation, comprising a backing (2) and at least one layer of an adhesive (5), wherein the adhesive (5) has two or more sublayers (3, 4) and at least one of the sublayers (3) is present in a mechanically tensioned state.

2. The adhesive sheet of claim 1, wherein the adhesive layer (5) has an inner sublayer (3), which faces the backing (2), and an outer sublayer (4), which is remote from the backing (2), the outer sublayer (4) being adhesive.

3. The adhesive sheet of claim 1, wherein between the inner sublayer (3) and the outer sublayer (4) there are further sublayers disposed.

4. The adhesive sheet of claim 3, wherein the inner sublayer (3) or one of the further sublayers is a sublayer in a mechanically tensioned state and the outer sublayer (4) is adhesive.

5. The adhesive sheet of claim 1, wherein the layer of adhesive (5) possesses anisotropic properties.

6. The adhesive sheet of claim 1, wherein the backing is coated on both sides with a layer of adhesive (5, 5′), at least one of the two layers of adhesive (5, 5′) comprising two or more sublayers (3, 4) of which at least one is present in a mechanically tensioned state.

7. The adhesive sheet of claim 6, wherein each of the two layers of adhesive (5, 5′) comprises two or more sublayers (3, 3′, 4, 4′) of which at least one (3, 3′) is present in a mechanically tensioned state.

8. The adhesive sheet of claim 6, wherein only one of the two layers of adhesive (5, 5′) comprises two or more sublayers (3, 4) of which at least one (3) is present in a mechanically tensioned state.

9. A process for producing an adhesive sheet of claim 1, wherein an adhesive which comprises two or more sublayers is coated in the drawn state onto a sheetlike material (2, 6) to give the layer of adhesive (5), at least one of the sublayers (3, 4) of the layer of adhesive (5) being present in a mechanically tensioned state.

10. The process of claim 9, wherein the sheetlike material is a backing (2) or a release liner (6).

11. The process of claim 9 wherein the layer of adhesive (5) is crosslinked after having been coated onto the sheetlike material.

12. The process of claim 9, comprising
(a) coating a first surface of the backing (2), having a first and second surface, with layer of adhesive (5) in the drawn state;
(b) crosslinking the layer of adhesive (5) on the backing (2); and
(c) optionally lining the layer of adhesive (5) with a release liner (6).

13. The process of claim 12, comprising
(d) coating the second surface of the backing (2) with a second adhesive in the drawn state, the second layer of adhesive (5′) which is applied to the second surface being the same as or different from the first layer of adhesive (5) applied to the first surface of the backing (2) in step (a) in terms of its construction or its composition; and
(e) crosslinking the second layer of adhesive (5′) on the backing (2).

14. Punched products produced by punching an adhesive sheet (1) of claim 1.
